(19) United States
(12) Patent Application Publication
(10) Pub. No.: US 2017/0074605 A1
(43) Pub. Date: Mar. 16, 2017

(54) TUNABLE THERMOSTATIC MATERIALS AND METHODS FOR PREPARATION AND USE

(71) Applicant: EMPIRE TECHNOLOGY DEVELOPMENT LLC, Wilmington, DE (US)

(72) Inventor: Nasser Mohieddin ABUKHDEIR, Waterloo, Ontario (CA)

(73) Assignee: EMPIRE TECHNOLOGY DEVELOPMENT LLC, Wilmington, DE (US)

(21) Appl. No.: 15/122,094

(22) PCT Filed: Feb. 26, 2014
(86) PCT No.: PCT/US14/18634

§ 371 Date: Aug. 26, 2016

(51) Int. Cl. F28F 23/00; C09K 19/38; F28D 15/02; B65D 81/18; A61J 1/14; B65D 85/72; C09K 5/06; C09K 19/54

(52) U.S. Cl. CPC F28F 23/00; C09K 5/066; C09K 5/063; C09K 19/3804; C09K 19/544; B65D 81/18; A61J 1/1468; B65D 85/72; F28D 15/02

(57) ABSTRACT

Thermostatic heating or cooling materials and method for making and using the materials are disclosed. The thermostatic materials may be usable as packaging material and may include a mixture of at least two materials which exhibit a liquid crystalline (LC) phase, or mesophase. Mixtures of two or more compatible LC components may provide a tunability for both operating temperature (temperature control) and latent heat of transition (cooling capacity).

### BACKGROUND

Phase-change materials (PCM) are substances with a high heat of fusion which, upon changing phases between solid, liquid or gas at a certain temperature, are capable of storing and releasing large amounts of energy. For example, heat may be absorbed when the material changes from solid to liquid, and then released upon change from liquid to solid. Initially, solid-liquid PCMs exhibit a temperature rise as they absorb heat. However, when PCMs reach the temperature at which they change phase (their melting temperature) they absorb large amounts of heat at an almost constant temperature. The PCMs continue to absorb heat without a significant rise in temperature until all the material is transformed to the liquid phase. When the ambient temperature around a liquid material falls, the PCM re-solidifies, releasing the stored latent heat.

One type of PCM may include materials that exhibit a liquid crystal phase, or mesophase. Liquid crystalline materials do not show a simple transition from solid to liquid, but have transitions involving at least one intermediate (mesomorphic) phase. The mechanical properties and the symmetry properties of the intermediate phases are between those of a liquid and those of a crystal. In a mesomorphic state, a liquid crystal may flow like a liquid while its molecules may be orientationally or positionally ordered in a crystal-like way.

Traditional phase cooling mechanisms involve a PCM which provides cooling through evaporation (changing from liquid to gas) or melting (changing from solid to liquid) at a fixed operating temperature (material dependent). When the process is not kinetically limited (for example, when the phase-change occurs too slowly), the total cooling capacity may be proportional to the mass of the consumable in that the latent heat of transition is fixed (material dependent). Additionally, the cooling delivery is limited to operating temperatures above the melting/evaporation temperature of the material.

This traditional approach has two significant disadvantages: (1) the operating temperature of the cooling device is limited to the melting/evaporation temperature of the consumable (and is, therefore, not tunable or adjustable), and (2) the total cooling capacity is limited to the mass and latent heat of transition of the phase change material, which is also fixed.

### SUMMARY

An alternative class of phase-change materials for thermostatic heating or cooling includes mixtures of at least two materials which exhibit a liquid crystalline (LC) phase. Mixtures of two or more compatible LC components provide an advantageous property of being tunable for both operating temperature (temperature control) and latent heat of transition (cooling capacity). This allows both the operating temperature and the latent heat to be “tuned” depending on the desired temperature requirements where precise thermostatic conditions may be required. Furthermore, LC materials exist that could provide both structural and cooling functionality in the form of LC polymers and block copolymer materials.

In an embodiment, a thermostatic material includes a mixture of a plurality of mesogens, wherein the plurality of mesogens form a homogeneous mesophase state.

In an embodiment, a method of regulating temperature of an article includes providing a thermostatic material that includes a mixture of a plurality of mesogens, wherein the plurality of mesogens form a homogeneous mesophase state, placing the thermostatic material at least adjacent at least one surface of the article, wherein the thermostatic material undergoes a phase transition as a surrounding temperature of the article approaches a phase transition temperature of the thermostatic material, and the thermostatic material exchanges heat with the article during the phase transition to regulate the temperature of the article.

In an embodiment, a thermostatic packaging includes a thermostatic material configured to regulate temperature within the packaging. The thermostatic material includes a mixture of a plurality of mesogens, wherein the plurality of mesogens form a homogeneous mesophase state.

In an embodiment, a method of making a thermostatic material includes mixing at least a first mesogen with a second mesogen, wherein the first mesogen and second mesogen are in either isotropic liquid or liquid crystalline states to form a mesogen mixture.

### DESCRIPTION OF DRAWINGS

For a fuller understanding of the nature and advantages of the present technologies, reference should be had to the following detailed description taken in connection with the accompanying drawings, in which:

FIG. 1 provides representative structures of two examples of liquid crystals according to embodiments.

FIG. 2 depicts a representative phase change diagram for a eutectic mixture of components according to embodiments.

FIGS. 3A-3D depict examples of thermostatic materials constructed according to embodiments.

FIG. 4 depicts an illustrative system for producing a thermostatic sheet according to an embodiment.

### DETAILED DESCRIPTION

Before the present compositions and methods are described, it is to be understood that they are not limited to the particular compositions, methodologies or protocols described, as these may vary. It is also to be understood that the terminology used in the description is for the purpose of describing the particular versions or embodiments only, and is not intended to limit the scope of the embodiments.

Phase-change materials that are “tunable” may be provided by using phase-change materials (PCMs) that exhibit phase-ordering. Phase-ordering materials may include liquid crystalline materials and self-assembled materials. Liquid crystals (LCs) are matter in a state that has properties between those of conventional liquid and those of solid crystal. For example, a liquid crystal may flow like a liquid, but its molecules may be oriented in a crystal-like way. These materials exhibit what are called “mesophases” which are phases that exist between the liquid phase of the material and the crystalline solid phase of the material. Different materials may exhibit one or more transitions to a mesophase, and the phase transitions occur at a fixed critical temperature.

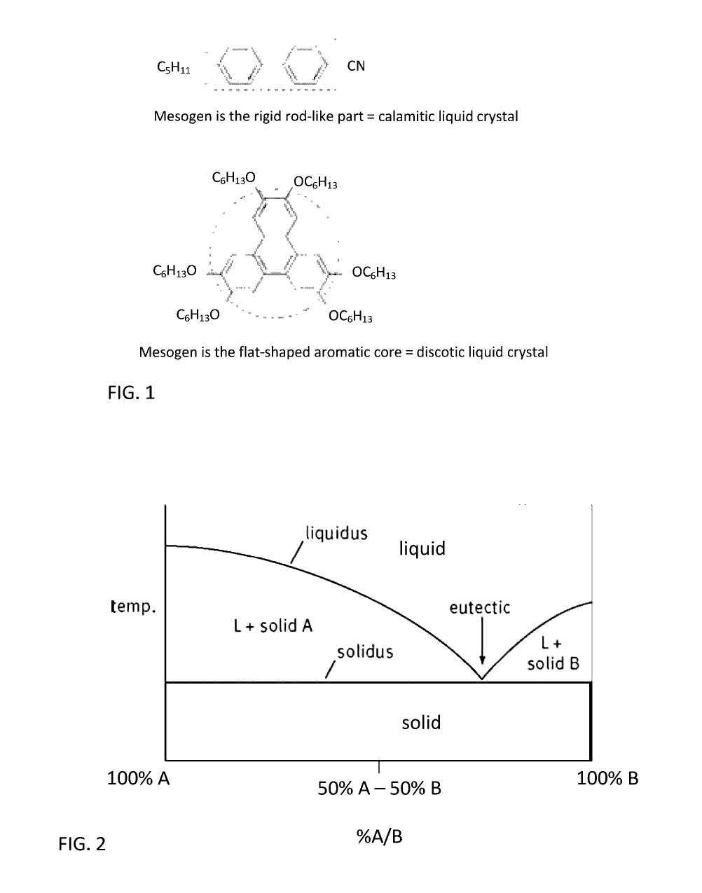

A mesogen is a fundamental unit of a liquid crystal and induces structural order in the crystals. FIG. 1 generally depicts non-limiting examples of liquid crystals and their mesogens. A liquid-crystalline molecule may include a rigid moiety, the mesogen, and one or more flexible parts. The mesogen may act to align the molecules in one direction, while the flexible parts may induce fluidity in the liquid crystal. A balance of these two parts is essential in forming liquid-crystalline materials.

In an embodiment, a thermostatic material may include a mixture of a plurality of mesogens, wherein the plurality of mesogens form a homogeneous mesophase state. Materials selected for a tunable thermostatic material should be miscible without destabilization of the shared phase transition. That is, if compound A and compound B both exhibit the same type of mesophase, which may occur at different critical temperatures for each of the compounds, a mixture of A and B will also exhibit this mesophase. In an embodiment, the mesophase state may be a liquid crystalline mesophase, and the material may have a first transition from a solid phase to the mesophase, and may have additional transitions from the mesophase to another mesophase, or from the mesophase to a liquid phase, wherein the temperature at which the transition occurs is often indicated as the critical temperature.

The effects produced by mixing of the mesogens may include a change in the critical temperature, a change in the latent heat of phase transition, or both. To provide a tunable phase change composite material, components that are both miscible and exhibit compatible phase-order are identified, and, by selection of the components and the ratio of the components in the composite, the composite may be tunable for both operating temperature (temperature control) and latent heat of transition (cooling capacity).

In some embodiments, the mixture of mesogens may be tuned to have at least one solid to mesophase transition at a temperature of about 0° C. to about 30° C., and may have at least one mesophase to liquid transition temperature that is greater than the at least one solid to mesophase transition temperature. In embodiments, the mixture of mesogens may be tuned to have at least one transition from mesophase to liquid at a temperature of greater than about 30° C. As examples, mixture of mesogens may be configured to have at least one solid to mesophase transition at a temperature of about 0° C., about 1° C., about 2° C., about 3° C., about 4° C., about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., about 30° C., or any temperature between any of the listed temperatures. As examples, mixture of mesogens may be configured to have at least one mesophase to liquid transition at a temperature that may be one of the above values, but greater than the solid to mesophase transition temperature, or alternatively may be about 31° C., about 32° C., about 33° C., about 34° C., about 35° C., about 36° C., about 37° C., about 38° C., about 39° C., about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 56° C., about 57° C., about 58° C., about 59° C., about 60° C., or any temperature between any of the listed temperatures, or greater than the listed temperatures.

In an embodiment, the mixture of mesogens may be tuned to have at least one solid to mesophase latent heat of transition of at least about 10 kJ/kg. In some embodiments, the mixture of mesogens may be tuned to have at least one solid to mesophase latent heat of transition of about 10 kJ/kg to about 100 kJ/kg. As non-limiting examples, mixture of mesogens may be configured to have a solid to mesophase latent heat of transition of about 10 kJ/kg, about 15 kJ/kg, about 20 kJ/kg, about 25 kJ/kg, about 30 kJ/kg, about 35 kJ/kg, about 40 kJ/kg, about 45 kJ/kg, about 50 kJ/kg, about 55 kJ/kg, about 60 kJ/kg, about 65 kJ/kg, about 70 kJ/kg, about 75 kJ/kg, about 80 kJ/kg, about 85 kJ/kg, about 90 kJ/kg, about 95 kJ/kg, about 100 kJ/kg, or any value between any of the listed values.

In an embodiment, the mixture of mesogens may be tuned to have at least one mesophase to liquid latent heat of transition of at least about 10 kJ/kg. In some embodiments, the mixture of mesogens may be tuned to have at least one mesophase to liquid latent heat of transition of about 10 kJ/kg to about 100 kJ/kg. As non-limiting examples, mixture of mesogens may be configured to have a mesophase to liquid latent heat of transition of about 10 kJ/kg, about 15 kJ/kg, about 20 kJ/kg, about 25 kJ/kg, about 30 kJ/kg, about 35 kJ/kg, about 40 kJ/kg, about 45 kJ/kg, about 50 kJ/kg, about 55 kJ/kg, about 60 kJ/kg, about 65 kJ/kg, about 70 kJ/kg, about 75 kJ/kg, about 80 kJ/kg, about 85 kJ/kg, about 90 kJ/kg, about 95 kJ/kg, about 100 kJ/kg, or any value between any of the listed values.

In an embodiment, the plurality of mesogens and the proportions in the mixture may be selected so that the mesogens form a eutectic composition. A eutectic composition is a composition in which the proportion of the constituents is configured to provide the lowest possible melting/freezing temperature for the composition. At the eutectic composition, all of the constituents change between liquid and solid at the same temperature. In all other proportions, the mixture may not have a uniform melting point, and one or more of the components may be solid while one other or more of the components may be a liquid. A non-limiting example of a eutectic diagram is depicted in FIG. 2.

A composition as represented in FIG. 2 may include two components, A and B. At the eutectic, approximately 25% A and 75% B, the composition changes between all solid and all liquid at the eutectic temperature (the solidus line and liquidus lines meet). If the proportion of A is greater, for example approximately 50% A and 50% B, the solidus and liquidus separate and between the two lines, component B is liquid while component A remains solid. Similarly, if the proportion of B is greater, for example approximately 10% A and 90% B, between the solidus and liquidus lines, component A is liquid while component B remains solid.

In an embodiment, a composite mixture may be configured to be tunable for the solid-mesophase transition temperature, the liquid-mesophase transition temperature, or both. A thermostatic material may include a mixture of at least first mesogens and second mesogens, wherein the first mesogens may have a first solid-mesophase transition temperature and a first liquid-mesophase transition temperature, and the second mesogens may have a second solid-mesophase transition temperature and a second liquid-mesophase transition temperature. The first solid-mesophase transition temperature may be different from the second solid-mesophase transition temperature, and the first liquid-mesophase transition temperature may be different from the second liquid-mesophase transition temperature. The resultant thermostatic material, a mixture of the first and second mesogens, may have a third solid-mesophase transition temperature that is different from the first solid-mesophase transition temperature, the second solid-mesophase transition temperature, or both, and may have a third liquid-mesophase transition temperature that may be different from the first liquid-mesophase transition temperature, the second liquid-mesophase transition temperature, or both. Variations in the ratio of the amount of the first mesogens with respect to the amount of the second mesogens, may provide variations in the third solid-mesophase transition temperature, the third liquid-mesophase transition temperature, or both.

In an embodiment, a composite mixture may be configured to be tunable for the latent heat of solid-mesophase transition, the latent heat of liquid-mesophase transition, or both. A thermostatic material may include a mixture of at least first mesogens and second mesogens, wherein the first mesogens may have a first latent heat of solid-mesophase transition and a first latent heat of liquid-mesophase transition, and the second mesogens may have a second latent heat of solid-mesophase transition and a second latent heat of liquid-mesophase transition. The first latent heat of solid-mesophase transition may be different from the second latent heat of solid-mesophase transition, and the first latent heat of liquid-mesophase transition may be different from the second latent heat of liquid-mesophase transition. The resultant thermostatic material, a mixture of the first and second mesogens, may have a third latent heat of solid-mesophase transition that is different from the first latent heat of solid-mesophase transition, the second latent heat of solid-mesophase transition, or both, and may have a third latent heat of liquid-mesophase transition that may be different from the first latent heat of liquid-mesophase transition, the second latent heat of liquid-mesophase transition, or both. Variations in the ratio of the amount of the first mesogens with respect to the amount of the second mesogens, may provide variations in the third latent heat of solid-mesophase transition, the third latent heat of liquid-mesophase transition, or both.

A thermostatic material may include a eutectic mixture of liquid crystals, wherein the liquid crystals provide the mesogens, and the eutectic mixture of liquid crystals forms a homogeneous mesophase state. The eutectic mixture of liquid crystals may include at least first liquid crystals having at least first mesogens, and second liquid crystals having at least second mesogens.

In an embodiment, the liquid crystals in the tunable thermostatic material may by polymeric liquid crystals that form a homogeneous mesophase state. Polymeric liquid crystals (PLCs) may provide greater latent heat of transition (cooling capacity) than regular liquid crystals, and may also provide increased structural rigidity that may make the PLCs better suitable for producing packaging materials. The polymer liquid crystals may include at least first polymer liquid crystals that include at least the first mesogens and second polymer liquid crystals that include at least the second mesogens. The first polymer liquid crystals and the second polymer liquid crystals may each independently be selected from main-chain polymer liquid crystals, side-chain polymer liquid crystals, or a combination thereof.

In some embodiments, the thermostatic material may include a mixture of polymeric liquid crystals (PLCs) and liquid crystals (LCs), wherein, for example, the polymeric liquid crystals may include the first mesogens and liquid crystals may include the second mesogens. Some examples of PLC/LC pairings that may provide tunable thermostatic materials may include, but are not limited to:
poly {6-(4-cyanobiphenyl-4′-yloxy)hexyl acrylate} and 4-cyano-4′-hexoxybiphenyl to produce a thermostatic material having a liquid/mesophase critical temperature range of about 75° C. to about 125° C. and a mesophase/solid critical temperature range of about 0° C. to about 40° C.;
poly {4-(6-acryloyloxyhexyl-1-oxyl)benzoic acid} and 4-cyano-4′-hexoxybiphenyl to produce a thermostatic material having a liquid/mesophase critical temperature of about 175° C. and a mesophase/solid critical temperature range of about 0° C. to about 90° C.; and
poly {oxy(tert-butyl-1,4-phenylene)oxycarbonyl-1,4-phenyleneoxy-1,6-hexanediyloxy-1,4-phenylenecarbonyl and tert-butylhydroquinone di-4-(hexyloxy)benzoate to produce a thermostatic material having a liquid/mesophase critical temperature range of about 90° C. to about 240° C. and a mesophase/solid critical temperature range of about 10° C. to about 70° C.

Tunable thermostatic materials may also include mesogens that are provided by compounds of the formula

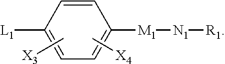

In various embodiments, L₁ may be alkyl, alkenyl, alkoxyl, —H, —CN, —SCN, —CH₂F, —CHF₂, or —CF₃; M₁ may be a bond, phenylene, —C≡C—, —CH═CH—, —C(O)—O—, —O—C(O)—, —CH═N—, —N═CH—, —N═N—, —N(O)═N—, or —N═N(O)—; N₁ may be a

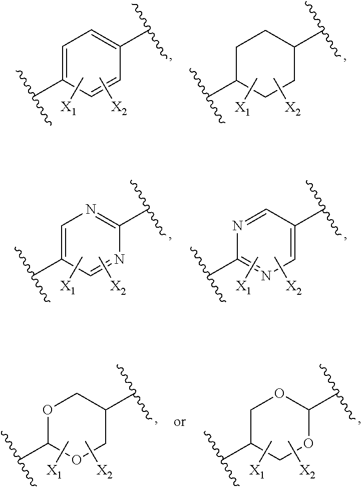

wherein X₁ may be hydrogen or fluorine, and X₂, may be hydrogen or fluorine; R₁ may be alkyl, alkenyl, alkoxyl, cycloalkyl, alkyl substituted cycloalkyl, or alkyl substituted aryl, —H, —CN, —SCN, —CH₂F, —CHF₂, —CF₃; X₃ may be hydrogen or fluorine; and X₄ may be hydrogen or fluorine. In an embodiment, X₁, X₂, X₃, and X₄ may each be hydrogen. In embodiments, any of the alkyl, alkenyl, and alkoxyl may independently be unsubstituted, straight chain C1 to about C14 groups.

In one configuration of compounds of the formula

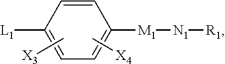

L₁ is —CN; M₁ is a bond; N₁ is

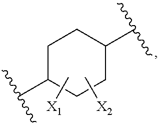

wherein X₁ is hydrogen or fluorine, and X₂ is hydrogen or fluorine; X₃ is hydrogen or fluorine; X₄ is hydrogen or fluorine; and R₁ is alkyl, alkoxyl, cycloalkyl, alkyl substituted cycloalkyl, or alkyl substituted aryl. In an embodiment, X₁, X₂, X₃, and X₄ are each hydrogen. In embodiments, any of the alkyl, alkenyl, and alkoxyl may independently be unsubstituted, straight chain C1 to about C14 groups.

As an example only, compounds of formula

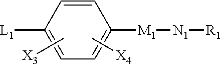

may include cyano-biphenyl compounds, such as 4-biphenylcarbonitrile (M₁ is a bond, N₁ is

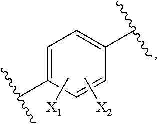

R₁, X₁, X₂, X₃, and X₄ are —H, and L₁ is —CN) and derivatives thereof. Another variant of the above compound may include 2-biphenylcarbonitrile (cyanobiphenyl),

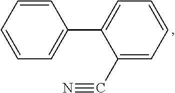 [SMILES: N#Cc1ccccc1-c1ccccc1]

and derivatives thereof.

Thermostatic materials configured in a manner as provided above may be used for regulating the temperature of a wide variety of articles. Thermostatic materials may keep an item cool, such as, for example, keeping a food item from spoiling by maintaining the temperature of the food item below a threshold temperature, such as about 5° C. Thermostatic materials may also be used to keep an item warm/hot, such as, for example, keeping a food item warm for consumption by maintaining the temperature of the food item above a threshold temperature, such as about 60° C.

However, for use in temperature regulation, consideration should also be given for containment of the liquid phase for when the thermostatic materials may reach the mesophase to liquid transition. Solid materials have a definite shape and structure and may be formed and retained as shaped articles. As such, liquid crystal mixtures in their solid state may not require any additional containment during use. In liquid form however, the shape and structure are no longer definite and the liquid crystals in the liquid state will disperse unless contained by a barrier material.

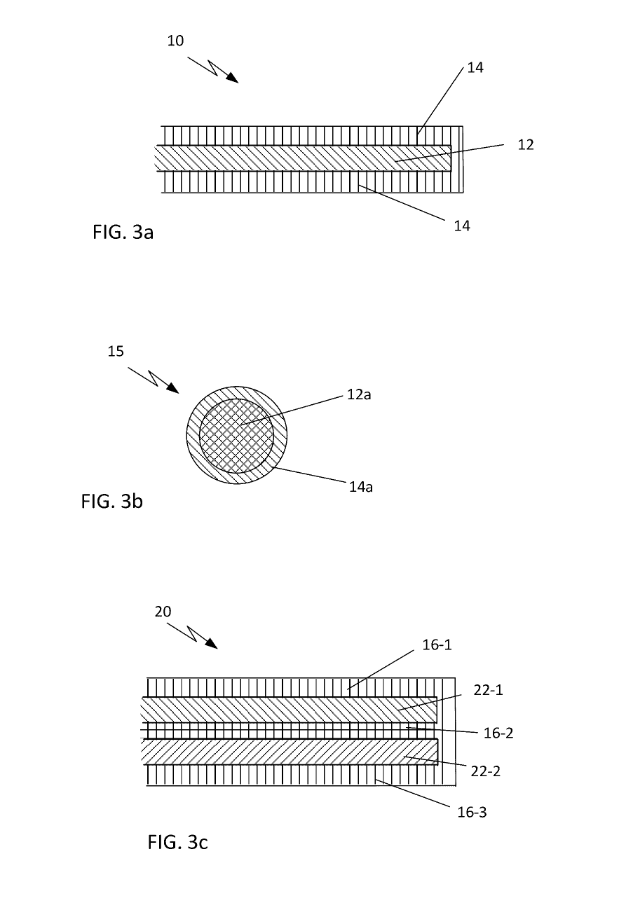

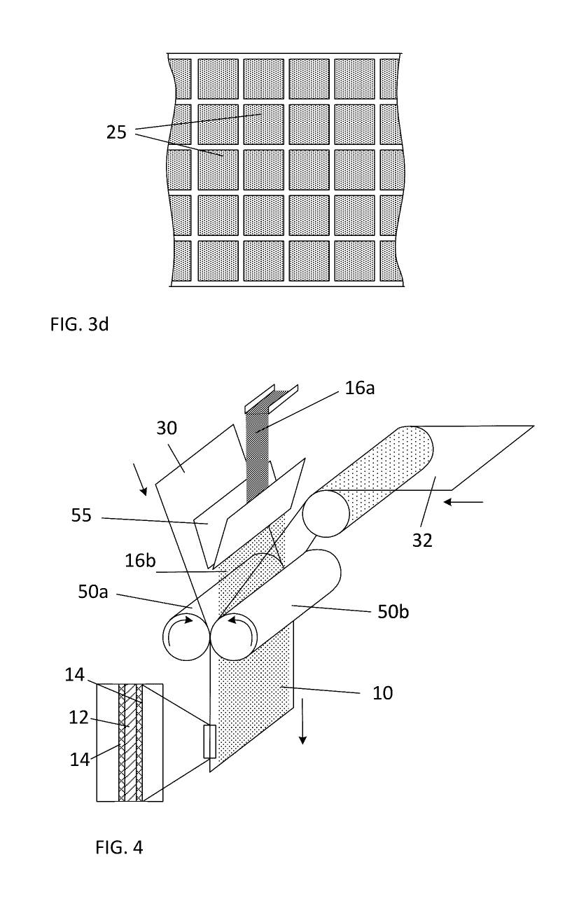

As represented in FIGS. 3A-3D, one manner for containment may include providing an outer shell to encase the mesogens. In a thermostatic packaging 10, such an outer shell may be a layer of polymeric material 14 that completely surrounds and encases the liquid crystal mixture 12 to thereby contain liquids as they form. Some examples of polymers that may be used to provide a polymer shell 14 may include, but are not limited to, polyacrylate, polyethylene, polypropylene, polylactic acid, polycarbonate, and polyethylene terephthalate, or any combination thereof. In an embodiment as represented in FIG. 3B, a thermostatic material may be formed as beads 15, wherein a liquid crystal mixture 12a may be coated with a polymer 14a.

In another embodiment, solid liquid crystal mixture may be dispersed into an uncured polymer mixture, and the polymer may be cured to disperse the liquid crystal mixture within the polymer. A polymer dispersed liquid crystal may be formed through a phase-separation approach. A mixture of polymer and liquid crystal may be formed under processing conditions, and the processing conditions may be changed such that the mixture is no longer stable, resulting in a phase-separation. There are three different approaches for phase-separation that include thermal, polymerization, and solvent. The initial mixture may be composed of a monomer and a LC. Phase-separation may be induced through polymerization of the monomer, yielding mechanical robust composites.

In an embodiment, as represented in FIG. 3C, a thermostatic material 20 may be formed as a composite of mixture compositions 22-1, 22-2 interposed with polymer layers 16-1, 16-2, 16-3. The polymer layers 16-1, 16-2, 16-3 may each be the same, or different types of polymers, and the mixture compositions 22-1, 22-2 may each be the same, or different types of mixture compositions. As shown in FIG. 3D, the mixture compositions may be contained in cells or pockets 25 between the layers to prevent settling of the mixture within the layers. The polymer layers 16-1, 16-2, 16-3 may be sealed to one another along an outer edge of the polymer layers to fully contain the mixture.

FIG. 4 depicts a schematic representation of a system which may be used to seal a powdered mixture between two polymer films. A first polymer film 30 may be provided from a first supply roll (not shown) and a second polymer film 32 may be provided from a second supply roll (not shown). Each of the first and second polymer films 30, 32 may be fed downwardly and into a face-to-face orientation. The films may be fed to a sealing system to seal the films to one another. The sealing system may include two adjacent rollers 50a, 50b that may be pressure and/or sealing rollers. The films may be fed between the rollers and sealed to one another. A dry mixture 16a may be fed into a gravity distribution hopper 55 that disperses the mixture into a reactant stream 16b and distributes the material between the films 30, 32 prior to the sealing rollers 50a, 50b. The two films 30, 32 may be adhered together thermally or with an adhesive. Finished films 10 may then be used singly, or in multiple layers. Alternatively, finished films 10 may be substituted in the processing equipment for films 30 and/or 32. If used as both films 30 and 32, a resultant composite sheet may have four layers of polymer and three layers of the liquid crystal mixture. If used as one of the films 30 or 32, a resultant composite sheet may have three layers of polymer and two layers of the liquid crystal mixture.

To extend the temperature range of the thermostatic material, various ones of the mixture layers may be configured with different mixtures. For example, as shown in FIG. 3C, a layered material 20 for maintaining a cold temperature may have at least two separate mixture layers 22-1, 22-2, with the first layer 22-1 having a solid to mesophase transition temperature of about 3° C., and the second layer 22-2 having a solid to mesophase transition temperature of about 6° C. The composite may thereby be usable for one type of product that may require a temperature of around 3° C., and a second type of product that may require a temperature of around 6° C. A further embodiment, may for example include three layers with three transition temperatures.

A thermostatic packaging may include a thermostatic material configured to regulate temperature within the packaging. The thermostatic material may include a mixture of a plurality of mesogens, wherein the plurality of mesogens form a homogeneous mesophase state. As discussed above, the mesogens may be provided as a mixture of liquid crystals in any of the embodiments as previously described. This type of packaging may be used for containing a wide variety of products including but not limited to, for example, electronic devices, pharmaceutical drugs, vaccines, foods, and beverages. The packaging may be configured in a form required for specific materials, such as containers for drugs, vaccines, foods, or beverages, that may include configurations such as plates, trays, cups, tubes, cans, and boxes. The packaging may also be provided as bags or wraps. In other examples, the thermostatic material may be configured as a filling or cushioning material (such as packing peanuts) for placement into a package to regulate temperature of articles in the package while also preventing damage to the packaged article.

In an embodiment, a method of regulating temperature of an article may include providing a thermostatic material that includes a mixture of a plurality of mesogens, wherein the plurality of mesogens form a homogeneous mesophase state, and contacting at least one surface of the article with the thermostatic material. As the thermostatic material undergoes a phase transition as a surrounding temperature of the article approaches a phase transition temperature of the thermostatic material, the thermostatic material exchanges heat with the article during the phase transition to regulate the temperature of the article.

An exchange of heat between the thermostatic material and the article, to the article to keep the article warm, or from the article to keep the article cool, may occur during a phase change of the thermostatic material. The phase change may be a transition from solid phase to mesophase, mesophase to solid phase, mesophase to isotropic liquid phase, isotropic liquid phase to mesophase, or any combination thereof. In an embodiment, the exchanging of heat may include a lower-temperature conversion from a solid phase to a mesophase at a temperature of about 0° C., and a higher-temperature conversion from the mesophase to an isotropic liquid phase at a temperature of about 30° C.

By selection of the composition of the thermostatic material a thermostatic material may be tuned to function at a desired temperature. Thus, after determining a temperature at which an article is to be regulated, a thermostatic material may be configuring to have a phase transition temperature at the temperature at which the article is to be regulated. The thermostatic material may be configured by selecting mesogens having structurally similar mesophases at temperatures of about the temperature at which the article is to be regulated, and then mixing the mesogens at a mixing ratio selected to tune the phase transition temperature of the thermostatic material to the temperature at which the article is to be regulated.

As described above, the thermostatic material may be configured as a eutectic mixture of liquid crystals that include the mesogens, wherein the liquid crystals in the mixture are able to form a homogeneous mesophase state. In an embodiment, the liquid crystals may include polymer liquid crystals. In a variant embodiment, the thermostatic material may be a polymerized composite of the mesogens and at least one additional monomer. The at least one additional monomer may be an acrylate.

In configuration of the thermostatic material, consideration may also be given to encasing the liquid crystals to prevent leakage of liquefied liquid crystals. In one embodiment, this may include encasing the mixture of the mesogens with an outer shell material, that may be a polymer, for example. In a variant embodiment, the mixture of mesogens may be layered with polymer layers, and the polymer layers may be sealed along the edges to contain the mesogens within the layers.

A thermostatic material may be made by mixing at least a first mesogen with at least a second mesogen, wherein the first mesogen and the second mesogen are in isotropic liquid states to give a mesogen mixture. The thermostatic material may be tuned to have a phase transition temperature at a specified temperature by selecting appropriate first and second mesogens that each have structurally similar mesophases at the specified temperature.

After selection of the mesogens, the first mesogens and the second mesogens may be mixed at a mixing ratio selected to tune at least one phase transition temperature of the thermostatic material to the specified temperature. The first mesogens may have a first solid-mesophase transition temperature and a first liquid-mesophase transition temperature, and the second mesogens may have a second solid-mesophase transition temperature and a second liquid-mesophase transition temperature. The first solid-mesophase transition temperature may be different from the second solid-mesophase transition temperature, and the first liquid-mesophase transition temperature may be different from the second liquid-mesophase transition temperature.

The resultant thermostatic material, a mixture of the first and second mesogens, may have a third solid-mesophase transition temperature that is different from the first solid-mesophase transition temperature, the second solid-mesophase transition temperature, or both, and may have a third liquid-mesophase transition temperature that may be different from the first liquid-mesophase transition temperature, the second liquid-mesophase transition temperature, or both. Variations in the ratio of the amount of the first mesogens with respect to the amount of the second mesogens, may provide variations in the third solid-mesophase transition temperature, the third liquid-mesophase transition temperature, or both. By varying a ratio of an amount of the first mesogens with respect to an amount of the second mesogens in the mesogen mixture, the third solid-mesophase transition temperature may be tuned to a desired temperature, the third liquid-mesophase transition temperature may be tuned to a desired temperature, or both.

In an embodiment, at least one polymerizable monomeric moiety may be mixed with the mesogens, and the monomer may be polymerized. The monomers may be acrylates.

A method for making a thermostatic material may include providing polymer liquid crystals to provide at least one of the mesogens, in which case, the polymer liquid crystals may form a homogeneous mesophase state. The method may include providing at least first polymer liquid crystals having at least first mesogens, and second polymer liquid crystals having at least second mesogens. Alternatively, the method may include providing at least first polymer liquid crystals having the first mesogens, and second, non-polymeric, liquid crystals having the second mesogens. The method may include liquefying the liquid crystals so that the first mesogens and second mesogens are in their isotropic liquid states.

The thermostatic material may be configured to include any one of, or combination of any of the following combinations of liquid crystal materials:
a. poly {6-(4-cyanobiphenyl-4′-yloxy)hexyl acrylate} and 4-cyano-4′-hexoxybiphenyl;
b. poly {4-(6-acryloyloxyhexyl-1-oxyl)benzoic acid} and 4-cyano-4′-hexoxybiphenyl;
c. poly {oxy(tert-butyl-1,4-phenylene)oxycarbonyl-1,4-phenyleneoxy-1,6-hexanediyloxy-1,4-phenylenecarbonyl} and tert-butylhydroquinone di-4-(hexyloxy)benzoate;
d. TPB-x and 4′-pentyl-4-biphenylcarbonitril (5CB); and
e. TPB-x and 4′-pentyloxy-4-biphenylcarbonitrile (5-OCB).
   TPB is 1-(4-hydroxy-4′-biphenyl)-2-(4-hydroxyphenyl)butane, and x is an alkyl spacer of 4-15 carbons disposed between units of the 1-(4-hydroxy-4′-biphenyl)-2-(4-hydroxyphenyl)butane. In embodiments, x may be any of 4, 6-11, and 13-15.

To contain any liquefied mesogens that may form during use of the material, the method for making a thermostatic material may also include layering the mesogen mixture between a polymer layer, and sealing an outer edge of the polymer layers to contain the mesogen mixture. The mesogens mixture may be deposited on a first polymer layer, and a second polymer layer may be sealed to the first polymer layer to contain the mesogen mixture between the layers. Additional layers of mesogens and polymer may be provided as needed to provide a required degree of temperature maintenance, wherein more layers may provide a longer maintenance effect by including additional thermostatic material. The various mesogen layers may all be the same mixture composition, may all be different compositions, or any combination of compositions. Similarly, the polymer layers may all be the same polymer, or may all be different polymers, and the polymers may include, but are not limited to polyacrylate, polyethylene, polypropylene, polylactic acid, polycarbonate, and polyethylene terephthalate, or any combination thereof.

These technologies and embodiments illustrating the method and materials used may be further understood by reference to the following non-limiting examples.

### EXAMPLES

### Example 1

### Thermostatic Material for Maintaining a Cold Temperature

A thermostatic material that is capable of thermally insulating a cold food item at a temperature of about 5° C. includes a mixture of the polymeric liquid crystal poly {6-(4-cyanobiphenyl-4′-yloxy)hexyl acrylate} and the liquid crystal 4-cyano-4′-hexoxybiphenyl. The mixture includes about 90% by weight of the PLC and about 10% by weight of the liquid crystal to give the mixture a critical temperature of about 5° C. for the phase change from solid to mesophase.

### Example 2

### Thermostatic Material for Maintaining a Hot Temperature

A thermostatic material that is capable of thermally insulating a hot food item at a temperature of about 60° C. includes a mixture of the polymeric liquid crystal poly {4-(6-acryloyloxyhexyl-1-oxyl)benzoic acid} and the liquid crystal 4-cyano-4′-hexoxybiphenyl. The mixture includes about 90% by weight of the PLC and about 10% by weight of the liquid crystal to give the mixture a critical temperature of about 60° C. for the phase change from solid to mesophase.

### Example 3

### Method of Producing a Thermostatic Material

The thermostatic material, such as that of Example 1, is made by determining the temperature for which the thermostatic material will be used, selecting at least first and second mesogens having compatible mesophases that will provide the desired thermal buffering, and determining a ratio of the components that will provide the thermal buffering at the desired temperature. For the material of Example 1 having a thermal buffering at about 5° C., the polymeric liquid crystal poly {6-(4-cyanobiphenyl-4′-yloxy)hexyl acrylate} and the liquid crystal 4-cyano-4′-hexoxybiphenyl are used. About 90 wt % poly {6-(4-cyanobiphenyl-4′-yloxy)hexyl acrylate} and about 10 wt % 4-cyano-4′-hexoxybiphenyl will be mixed at ambient temperature in the presence of tetrahydrofuran solvent. The solvent will be evaporated under to cause the liquid crystals to first enter into a homogeneous mesophase state and then turn to their solid form. In their solid state, the crystals are powdered for further use.

### Example 4

### Thermostatic Packaging

The powdered crystals of Example 3 will be dispersed between sheets of polyethylene via a system as depicted in FIG. 4. The powdered crystals will be dispersed vertically between two polyethylene sheets and the sheets will be sealed together to form a thermostatic wrap for being wrapped around an item that requires temperature buffering at about 5° C. during transport or short-term storage.

### Example 5

### Method of Maintaining a Food Item at a Cold Temperature

The thermostatic composite of Example 4 is usable as a wrap for insulating food items that are stored or transported in a warm ambient environment. The food items may be cheeses, chocolates or any food item that can spoil or deform under heat, for example above 20° C. The food items will be wrapped with one or more layers of the thermostatic wrap. Accordingly, the food item will be surrounded with the composite material. During transport or storage, as the ambient temperature rises to at or above the solid to mesophase phase change temperature, the material will absorb heat from the ambient surroundings as the phase change material enters the mesophase, thereby providing insulation to the food items. The thermostatic composite is expected to maintain the food items at about 4° C. to about 5° C. under varying temperature escalations of the surrounding environment.

### Example 6

### Method of Maintaining a Food Item at a Hot Temperature

The thermostatic composite of Example 2 will be provided in sheets as described above in Example 4, and the sheets will be formed into thermally insulating bags for thermally insulating warm food items that are transported in a cooler ambient environment. The food items may be delivery pizzas, for example, or any food items that should be kept warm or hot, for example above 60° C. A thermal bag may be constructed of the composite material so that a pizza box container may fit within the bag. Once a pizza is baked and ready for delivery, the pizza may be placed within the delivery box, that may then subsequently be placed within the insulating bag to keep the pizza hot during delivery. At the indicated temperatures, the crystals will be in a liquid state. During transport, since the ambient temperature is less than a phase change temperature of the phase change material, the phase change material will emit heat as the phase change material changes from the liquid state to the mesophase, thereby providing heat to the food item to keep the food item from cooling. The thermostatic composite is expected to maintain the food item at about 60° C. to about 61° C. in a cooler surrounding environment.

In embodiment, the term “alkyl” or “alkyl group” may refer to a branched or unbranched hydrocarbon or group of 1 to 20 carbon atoms, such as but not limited to methyl, ethyl, n-propyl, isopropyl, n-butyl, isobutyl, t-butyl, octyl, decyl, tetradecyl, hexadecyl, eicosyl, tetracosyl and the like. In embodiments, “Cycloalkyl” or “cycloalkyl groups” may include branched or unbranched hydrocarbons in which all or some of the carbons are arranged in a ring, such as but not limited to cyclopentyl, cyclohexyl, methylcyclohexyl and the like. In embodiments, the term “lower alkyl” includes an alkyl group of 1 to 10 carbon atoms, or 1 to 6 carbon atoms.

In embodiments, the term “alkenyl” or “alkenyl group” may refer to a branched or unbranched hydrocarbon or group of 1 to 20 carbon atoms based on an alkene, or characterized by a double bond, such as but not limited to ethenyl, propenyl, butenyl, pentenyl, hexenyl, and the like.

In embodiments, the term “alkoxyl” or “alkoxyl group” may refer to an alkyl group singularly bonded to oxygen, or R—O, wherein R is alkyl, such as but not limited to methoxy and ethoxy and the like.

In embodiments, the term “aryl” or “aryl group” may refer to monovalent aromatic hydrocarbon radicals or groups consisting of one or more fused rings in which at least one ring is aromatic in nature. Aryls may include but are not limited to phenyl, napthyl, biphenyl ring systems and the like. The aryl group may be unsubstituted or substituted with a variety of substituents including, but not limited to, alkyl, alkenyl, halide, benzylic, alkyl or aromatic ether, nitro, cyano and the like and combinations thereof.

In embodiments, “substituent” may refer to a molecular group that replaces a hydrogen in a compound and may include, but is not limited to, trifluoromethyl, nitro, cyano, C₁-C₂₀ alkyl, aromatic or aryl, halide (F, Cl, Br, I), C₁-C₂₀ alkyl ether, benzyl halide, benzyl ether, aromatic or aryl ether, hydroxy, alkoxy, amino, alkylamino (—NHR′), dialkylamino (—NR′R″) or other groups.

Although the present technology has been described in considerable detail with reference to certain preferred embodiments thereof, other versions are possible. Therefore the spirit and scope of the appended claims should not be limited to the description and the preferred versions contained within this specification.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A thermostatic material comprising a mixture of a plurality of mesogens, wherein the plurality of mesogens form a homogeneous mesophase state.

2.-26. (canceled)

27. The thermostatic material of claim 1, further comprising a polymeric outer shell encasing the mixture of the plurality of mesogens, wherein the polymeric shell includes polyacrylate, polyethylene, polypropylene, polylactic acid, polycarbonate, polyethylene terephthalate, or any combination thereof.

28.-29. (canceled)

30. The thermostatic material of claim 1, wherein the thermostatic material is a composite of polymer layers interposed with the mixture, the polymer layers sealed along an outer edge of the polymer layers to contain the mixture.

31. (canceled)

32. A method of regulating temperature of an article, the method comprising:
placing the thermostatic material at least adjacent at least one surface of the article, wherein the thermostatic material comprises a mixture of a plurality of mesogens, wherein the plurality of mesogens form a homogeneous mesophase state;
wherein the thermostatic material undergoes a phase transition as a surrounding temperature of the article approaches a phase transition temperature of the thermostatic material, and the thermostatic material exchanges heat with the article during the phase transition to regulate temperature of the article.

33. The method of claim 32, wherein providing the thermostatic material comprises:
determining a temperature at which the article is to be regulated; and
configuring the thermostatic material to have a phase transition temperature at the temperature at which the article is to be regulated.

34. The method of claim 33, wherein configuring the thermostatic material comprises:
selecting mesogens having structurally similar mesophases at temperatures of about the temperature at which the article is to be regulated; and
mixing the mesogens at a mixing ratio selected to tune the phase transition temperature of the thermostatic material to the temperature at which the article is to be regulated.

35. The method of claim 32, wherein placing the thermostatic material comprises placing a thermostatic material including polymer liquid crystals having at least one of the mesogens, and the polymer liquid crystals form a homogeneous mesophase state.

36. The method of claim 32, wherein placing the thermostatic material comprises placing a thermostatic material having an eutectic mixture of liquid crystals comprising the mesogens, and the eutectic mixture of liquid crystals forms a homogeneous mesophase state.

37. The method of claim 32, wherein placing the thermostatic material comprises placing a thermostatic material comprising a polymerized composite of the mesogens and at least one additional monomer.

38. The method of claim 37, wherein placing the thermostatic material comprises placing the thermostatic material comprising an acrylate monomer.

39. The method of claim 32, wherein placing the thermostatic material comprises placing a thermostatic material including an outer shell encasing the mixtures of the plurality of mesogens.

40. The method of claim 32, wherein placing the thermostatic material comprises placing a thermostatic material comprising a composite of polymer layers interposed with the mixture, the polymer layers sealed along an outer edge of the polymer layers to contain the mixture.

41. The method of claim 32, wherein placing the thermostatic material comprises placing a thermostatic material wherein the mixture is one or more of a solid and a liquid.

42. The method of claim 32, wherein placing the thermostatic material comprises placing a thermostatic material wherein the mixture is a mesophase.

43. The method of claim 32, wherein placing the thermostatic material comprises placing a thermostatic material wherein the mixture is a liquid.

44. The method of claim 32, wherein placing the thermostatic material comprises placing a thermostatic material having a eutectic mixture of the plurality of mesogens.

45. The method of claim 32, wherein the exchanging of heat between the thermostatic material and the article occurs during a phase change of the thermostatic material.

46. The method of claim 45, wherein exchanging of heat between the thermostatic material and the article comprises a transition from solid phase to mesophase, mesophase to solid phase, mesophase to isotropic liquid phase, isotropic liquid phase to mesophase, or any combination thereof.

47. The method of claim 46, wherein the exchanging of heat comprises a lower-temperature conversion from a solid phase to a mesophase at a temperature of about 0° C., and a higher-temperature conversion from the mesophase to an isotropic liquid phase at a temperature of about 30° C.

48. The method of claim 32, wherein regulating the temperature of an article comprises regulating the temperature of an electronic device, a pharmaceutical drug, a vaccine, a food, or a beverage.

49. A thermostatic packaging comprising a thermostatic material configured to regulate temperature within the packaging, the thermostatic material comprising a mixture of a plurality of mesogens, wherein the plurality of mesogens form a homogeneous mesophase state.

50. The thermostatic packaging of claim 49, wherein the packaging is configured to contain an electronic device.

51. The thermostatic packaging of claim 49, wherein the packaging is configured to contain a pharmaceutical drug, a vaccine, a food, or a beverage.

52. The thermostatic packaging of claim 49, wherein the packaging is a container of a pharmaceutical drug, or a container of a vaccine.

53. The thermostatic packaging of claim 49, wherein the packaging is a food container or a beverage container.

54.-68. (canceled)
